(19) United States
(12) Patent Application Publication
(10) Pub. No.: US 2002/0094810 A1
(43) Pub. Date: Jul. 18, 2002

(54) Uplink transmission with selective ARQ based on signal quality

(76) Inventor: Hassan I. Hassan, Apex, NC (US)

Correspondence Address: COATS & BENNETT, PLLC, P O BOX 5, RALEIGH, NC, 27602, US

(21) Appl. No.: 09/764,822

(22) Filed: Jan. 17, 2001

(51) Int. Cl. H04Q 7/20

(52) U.S. Cl. 455/424; 455/67.1

(57) ABSTRACT

Bandwidth efficiency is increased by tailoring the use of ARQ transmission techniques to those situations where the signal quality on the mobile terminal uplink channel is expected to be poor. The signal quality on a downlink channel may be examined prior to uplinking a message from a mobile terminal to a base station. In response to the examination indicating that the signal quality on the uplink channel is below a predetermined threshold, the mobile terminal assumes an ARQ transmission mode, but if the examination indicates that the signal quality is not below the threshold, the mobile terminal assumes an non-ARQ transmission mode. Advantageously, the message length may also be used to help determine whether the ARQ transmission mode should be used.

### BACKGROUND OF THE INVENTION

The present invention relates to transmission methods utilized by wireless communications mobile terminals, such as cellular telephones, and more particularly to the use of automatic retransmission request transmission techniques.

Wireless communications systems employ various techniques to handle erroneously received information. Generally speaking, these techniques include those which aid a receiver to correct the erroneously received information, e.g., forward error correction (FEC) techniques, and those which enable the erroneously received information to be retransmitted to the receiver, e.g., automatic retransmission request (ARQ) techniques. FEC techniques include, for example, convolutional or block coding of the data prior to modulation, where redundant information is added to the data to aid in the correction of certain errors. ARQ techniques involve analyzing received blocks of data for missing data and requesting retransmission of missing blocks. While these techniques aid in the accurate receipt of data, the use of such techniques necessarily consumes additional bandwidth. As such, it may be advantageous to limit the use of such techniques to situations where the benefit of the more robust transmission offsets the additional bandwidth consumed.

### BRIEF SUMMARY OF THE INVENTION

The present invention allows for more efficient use of bandwidth by tailoring the use of ARQ transmission techniques by wireless communications mobile terminals to those situations where the signal quality on the uplink channel is expected to be poor. The process includes examining the signal quality on a downlink channel when a message is to be uplinked from a mobile terminal to a base station. An ARQ transmission technique is selectively used to transmit the information on the uplink channel based on that examination of the downlink channel. For instance, in response to the examination indicating that the signal quality on the uplink channel is below a predetermined threshold, the mobile terminal assumes an ARQ transmission mode, but if the examination indicates that the signal quality is not below the threshold, the mobile terminal assumes an non-ARQ transmission mode. Advantageously, the message length may also be used to help determine whether the ARQ transmission mode should be used.

### BRIEF DESCRIPTION OF THE DRAWINGS

FIG. 1 shows a exemplary wireless communications system.

FIG. 2 shows one exemplary process flow for the present invention.

FIG. 3 shows another exemplary process flow for the present invention.

FIG. 4 shows one exemplary functional block diagram of a mobile terminal.

### DETAILED DESCRIPTION OF THE INVENTION

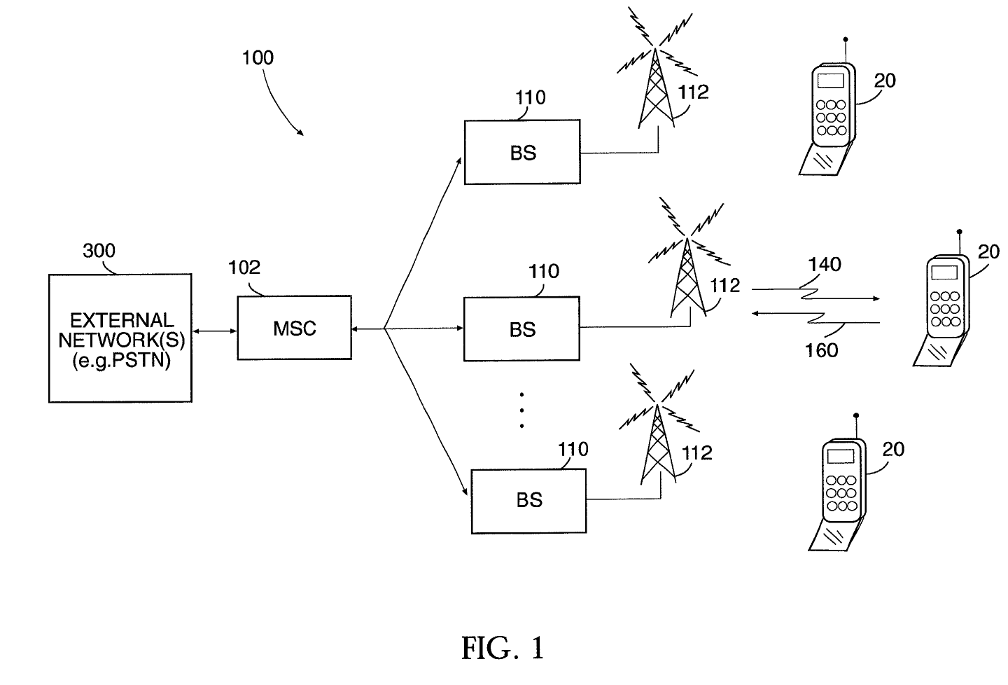

Referring now to the drawings, FIG. 1 is a schematic representation of the radiocommunication environment in which a mobile terminal 20 operates. Mobile terminal 20 is in the coverage area of a public land mobile network (PLMN) 100. PLMN 100 comprises one or more base stations 110, each coupled to an antenna 112. Each base station 110 provides radiocommunication services to mobile terminals 20 within its area of coverage, which is generally referred to as a cell. Each base station 110 connects to a mobile switching center (MSC) 102, which in turn connects to the Public Switched Telephone Network (PSTN) 300. The PLMN 100 may have more than one MSC 102 which interconnect to form a core network, as is well known in the art. Mobile terminal 20 and PLMN 100 may employ a wide variety of communication standards and protocols, which are published by organizations such as the Telecommunications Industry Association/Electronics Industry Association (TIA/EIA) and the European Telecommunication Standards Institute (ETSI), including without limitation Time Division Multiple Access (TDMA) standards such as TIA/EIA-136 and the Global System for Mobile Communications (GSM), Code Division Multiple Access (CDMA) standards such as TIA/EIA-95, Wideband Code Division Multiple Access (WCDMA) standards such as cdma2000, Universal Wireless Communications (UWC) 136, and satellite communication standards such those known as Globestar.

The transmissions between the mobile terminal 20 and the base station 110 may be conceptually divided into the downlink channel 140 for transmissions from the base station 110 to the mobile terminal 20 and the uplink channel 160 for transmissions from the mobile terminal 20 to the base station 110. While it is possible that the downlink channel 140 and the uplink channel 160 are merely different timeslots on the same physical frequency, this is not required and the downlink channel 140 may use one physical frequency and the uplink channel 160 another physical frequency.

For uplink transmissions, the mobile terminal 20 may employ any one of a wide variety of transmission techniques well known in the art that do not employ an automatic retransmission request (ARQ) approach. For simplicity, these non-ARQ techniques may be referred to herein as “normal” transmission techniques. While normal transmission techniques are suitable for the majority of conditions, it is not uncommon for the signal quality on the uplink channel 160 to be relatively poor, possibly leading to missing data when normal transmission techniques are used. As such, many communications standards (protocols) include provisions for ARQ transmission techniques. For instance, the communications standard known as TIA/EIA-136, which is incorporated herein by reference, includes provisions for ARQ (see TIA/EIA-136-133-A). The general operation of the various types of ARQ transmission techniques are well known to those in the art.

While TIA/EIA-136 and other standards allow for ARQ transmission techniques, the standards are believed to determine whether or not ARQ transmission techniques should be used based solely on whether the respective components (e.g., the mobile terminal 20 and the base station 110) are designed support the ARQ approach, and not based on the actual need for the ARQ approach based on signal conditions. In contrast, the present invention tailors the use of ARQ transmission techniques by mobile terminals 20 to those situations where the signal quality on the uplink channel 160 is expected to be poor, thereby using the more bandwidth efficient normal transmission techniques whenever possible.

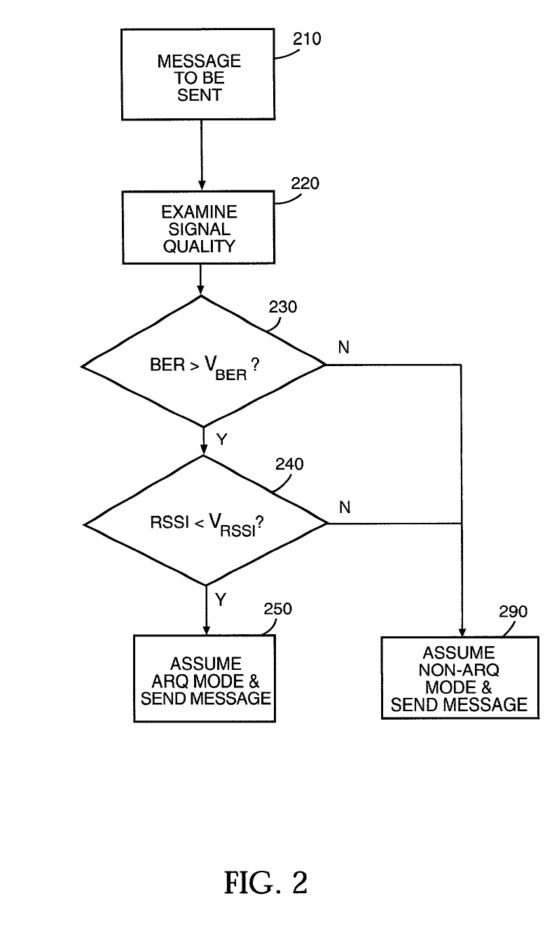

One process flow for transmitting information from the mobile terminal 20 to the base station 110 according to the present invention is shown in FIG. 2. When a message needs to be sent from the mobile terminal 20 to the base station 110 over a traffic channel (box 210), the mobile terminal 20 examines the signal quality of a downlink channel 140 (box 220) from the relevant base station 110. The downlink channel 140 may advantageously be the downlink traffic channel 140 associated with the uplink traffic channel 160 that will be used, but this is not required. The examination of the signal quality of the downlink channel 140 (box 220) may include, for example, measuring the Bit Error Rate (BER) and/or the Received Signal Strength (RSSI) of the downlink channel 140, or referencing recent measurements thereof. Continuing with BER and RSSI as representative examples, the BER of the downlink channel 140 is compared against a predetermined BER threshold value V_{BER} (box 230). A representative value of V_{BER} is three hundred. If the BER is not more than V_{BER} (box 230), then the mobile terminal 20 assumes a non-ARQ transmission mode (box 290) wherein the message is transmitted from the mobile terminal 20 to the base station 110 using a non-ARQ transmission mode. “Assuming” a mode in this context means that the mobile terminal 20 either changes to the desired mode or, if already in that mode, remains in the desired mode. If the BER is more than V_{BER} (box 230), then the RSSI is compared against a predetermined RSSI threshold V_{RSSI} (box 240). A representative value of V_{RSSI} is −111 dBm. If the RSSI not less than V_{RSSI} (box 240), then the mobile terminal 20 assumes a non-ARQ transmission mode (box 290) wherein the message is transmitted from the mobile terminal 20 to the base station 110 using a non-ARQ transmission technique. If the RSSI is less than V_{RSSI} (box 240), then the mobile terminal 20 assumes an ARQ transmission mode (box 250) wherein the message is transmitted from the mobile terminal 20 to the base station 110 using an ARQ transmission technique.

Using the approach shown in FIG. 2, the ARQ transmission techniques are used to transmit the message from the mobile terminal 20 to the base station 110 when both the BER and the RSSI of the downlink channel 140 indicate that the signal quality of the uplink channel 160 is bad enough to warrant the use of ARQ. Otherwise, the normal transmission techniques are used. In this manner, the ARQ transmission techniques, and the accompanying consumption of bandwidth, are selectively used depending on the expected signal quality of uplink channel 160.

In the above example, both the BER and the RSSI of the downlink channel 140 were used as indicators of the expected signal quality of the uplink channel 160. Of course, only one or the other need by used, but both may be advantageously used as a basis for determining whether ARQ or non-ARQ transmission techniques should be used. Also, other measures of signal quality on the downlink channel 140, known to those of skill in the art, may be used instead or in addition thereto.

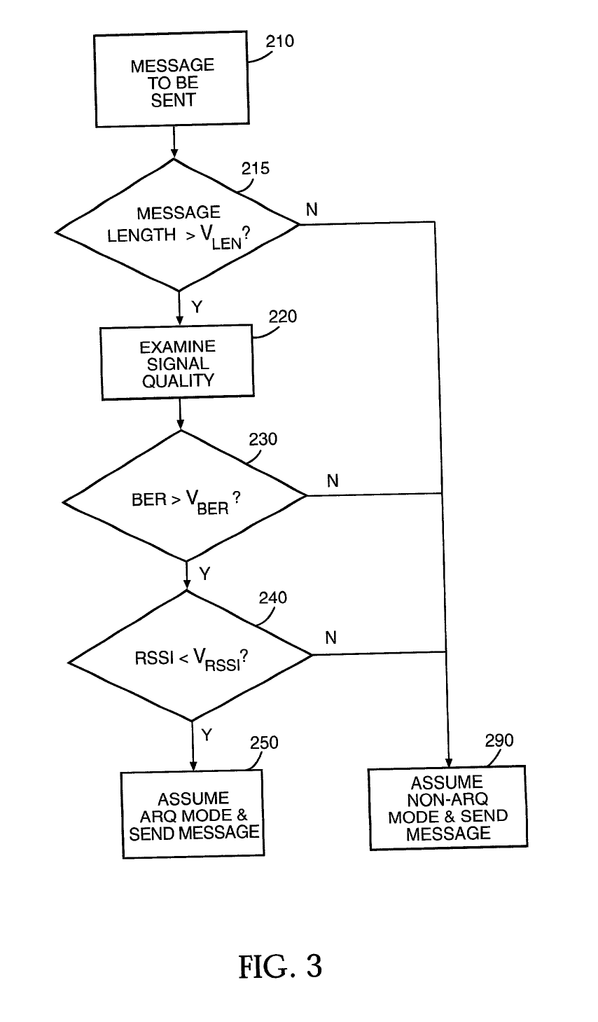

The use of ARQ transmission techniques consumes additional bandwidth, as discussed above. As such, it may be advantageous to alter the process flow of FIG. 2 to include a qualifying pre-test prior to examining the signal quality on the downlink channel 140. Such an approach is shown in FIG. 3. Much of the process of FIG. 3 is the same as in FIG. 2; however, prior to box 220, the process of FIG. 3 checks the length of the message to be sent (box 215). If the message length is determined to be not longer than a predetermined length V_{LEN}, such as forty bytes, the mobile terminal 20 assumes a non-ARQ transmission mode for the message (box 290) without examining the signal quality (box 220). On the other hand, if the message length is determined to be longer the predetermined length V_{LEN}, the mobile terminal 20 proceeds to examine the downlink signal quality as in FIG. 2 (box 220, etc.). As can be seen, the process of FIG. 3 limits the use of the selective ARQ application to relatively longer messages, accepting the risk of transmitting shorter messages with normal transmission techniques.

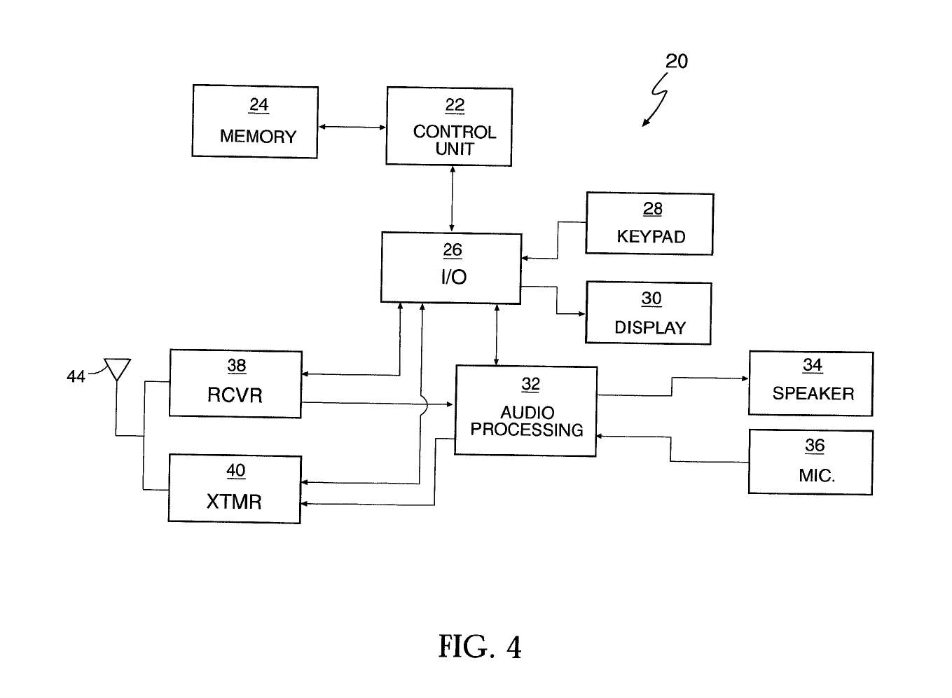

As discussed above, the present invention may be advantageously employed in wireless communications mobile terminals 20. One exemplary functional block diagram of a mobile terminal 20 is shown in FIG. 4. Mobile terminal 20 comprises a main control unit 22 for controlling the operation of the mobile terminal 20 and memory 24 for storing control programs and data used by the mobile terminal 20 during operation. Memory 24 may be contained in a removable smart card if desired. Input/output circuits 26 interface the control unit 22 with a keypad 28, display 30, audio processing circuits 32, receiver 38, transmitter 40, and positioning receiver 50. The keypad 28 allows the operator to dial numbers, enter commands, and select options. The display 30 allows the operator to see dialed digits, stored information, and call status information. The audio processing circuits 32 provide basic analog audio outputs to a speaker 34 and accept analog audio inputs from a microphone 36. The receiver 38 and transmitter 40 receive and transmit signals using shared antenna 44. The selective ARQ process of the present invention is typically carried out in the control unit 22 and/or by logic in the transmitter 40.

It should be noted that, as used herein, the term “mobile terminal” 20 may include a cellular radiotelephone with or without a multi-line display; a Personal Communications System (PCS) terminal that may combine a cellular radiotelephone with data processing, facsimile and data communications capabilities; a Personal Digital Assistant (PDA) may include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals 20 may also be referred to as “pervasive computing” devices.

The discussion above has assumed that the mobile terminal 20 is transmitting to a base station 110, such as that shown in FIG. 1. However, it should be noted that “base station” is intended to refer to any portion of the PLMN 100 that stays in a relatively fixed position and communicates directly with mobile terminals. As such, “base station” should be broadly construed and is intended to include such components as “pico base stations,” radio heads, what is sometimes referred to as “BMI” (base station, MSC, and interworking function), and the like.

The present invention may, of course, be carried out in other specific ways than those herein set forth without departing from the scope of the invention. The present embodiments are, therefore, to be considered in all respects as illustrative and not restrictive, and all changes coming within the meaning and equivalency range of the appended claims are intended to be embraced therein.

What is claimed is:

1. A method of transmitting a message from a wireless communications mobile terminal to a base station via an uplink channel, comprising:
examining a signal quality of a downlink channel at said mobile terminal;
uplinking said message from said mobile terminal to said base station using an ARQ transmission mode in response to said examining indicating that said signal quality is below a predetermined threshold.

2. The method of claim 1 wherein examining said signal quality comprises evaluating a BER associated with said downlink channel and wherein said predetermined threshold relates to a first predetermined BER.

3. The method of claim 1 wherein examining said signal quality comprises evaluating an RSSI associated with said downlink channel and wherein said predetermined threshold relates to a first predetermined RSSI.

4. The method of claim 1 wherein examining said signal quality comprises evaluating both a BER and an RSSI associated with said downlink channel and wherein said predetermined threshold considers both BER and RSSI.

5. The method of claim 1 wherein examining said signal quality of a downlink channel comprises examining said signal quality of a downlink traffic channel.

6. A method of transmitting a message from a wireless communications mobile terminal to a base station via an uplink channel, comprising:
examining a signal quality of a downlink channel from said base station to said mobile terminal at said mobile terminal;
transmitting said message from said mobile terminal to said base station on an uplink channel using:
an ARQ transmission mode in response to said examining indicating that said signal quality is below a predetermined threshold;
a non-ARQ transmission mode in response to said examining indicating that said signal quality is not below said predetermined threshold.

7. The method of claim 6 wherein examining said signal quality comprises evaluating a BER associated with said downlink channel and wherein said predetermined threshold relates to a first predetermined BER.

8. The method of claim 6 wherein examining said signal quality comprises evaluating an RSSI associated with said downlink channel and wherein said predetermined threshold relates to a first predetermined RSSI.

9. The method of claim 6 wherein examining said signal quality comprises evaluating both a BER and an RSSI associated with said downlink channel and wherein said predetermined threshold considers both BER and RSSI.

10. The method of claim 6 wherein examining said signal quality of a downlink channel comprises examining said signal quality of a downlink traffic channel.

11. A method of transmitting a message from a wireless communications mobile terminal to a base station via an uplink channel, comprising:
determining a length of said message;
in response to said message being longer than a first predetermined length:
examining a signal quality of a downlink channel from said base station to said mobile terminal at said mobile terminal;
transmitting said message from said mobile terminal to said base station on an uplink channel using:
an ARQ transmission mode in response to said examining indicating that said signal quality is below a predetermined threshold;
a non-ARQ transmission mode in response to said examining indicating that said signal quality is above said predetermined threshold;
in response to said message being not longer than said first predetermined length, transmitting said message from said mobile terminal to said base station on an uplink channel using a non-ARQ transmission mode.

12. The method of claim 11 wherein said first predetermined length is 40 bytes.

13. The method of claim 11 wherein examining said signal quality comprises evaluating a BER associated with said downlink channel and wherein said predetermined threshold relates to a first predetermined BER.

14. The method of claim 11 wherein examining said signal quality comprises evaluating an RSSI associated with said downlink channel and wherein said predetermined threshold relates to a first predetermined RSSI.

15. The method of claim 11 wherein examining said signal quality comprises evaluating both a BER and an RSSI associated with said downlink channel and wherein said predetermined threshold considers both BER and RSSI.

16. The method of claim 11 wherein examining said signal quality of a downlink channel comprises examining said signal quality of a downlink traffic channel.

17. A method of transmitting a message from a wireless communications mobile terminal to a base station via an uplink channel, comprising:
examining a signal quality of a downlink channel from said base station to said mobile terminal at said mobile terminal;
determining a length of said message;
transmitting said message from said mobile terminal to said base station on an uplink channel using an ARQ transmission mode in response to both said message being longer than a first predetermined length and said examining indicating that said signal quality is below a predetermined threshold; otherwise transmitting said message from said mobile terminal to said base station on said uplink channel using a non-ARQ transmission mode.

18. The method of claim 11 wherein said first predetermined length is 40 bytes.

19. The method of claim 11 wherein examining said signal quality comprises evaluating a BER associated with said downlink channel and wherein said predetermined threshold relates to a first predetermined BER.

20. The method of claim 11 wherein examining said signal quality comprises evaluating an RSSI associated with said downlink channel and wherein said predetermined threshold relates to a first predetermined RSSI.

21. The method of claim 11 wherein examining said signal quality comprises evaluating both a BER and an RSSI associated with said downlink channel and wherein said predetermined threshold relates to both BER and RSSI.

22. The method of claim 11 wherein examining said signal quality of a downlink channel comprises examining said signal quality of a downlink traffic channel.

23. A mobile terminal for communicating with a wireless communications system base station, said mobile terminal comprising:
an antenna;
control logic operatively connected to said antenna and adapted to:
examine a signal quality of a downlink channel from the base station to said mobile terminal received via said antenna;
initiate transmission of a message from said mobile terminal to the base station on an uplink channel using:
an ARQ transmission mode in response to said signal quality being below a predetermined threshold;
a non-ARQ transmission mode in response to said signal quality being not below said predetermined threshold; and
memory operatively connected to said control logic and storing therein at least one threshold value associated with said signal quality predetermined threshold.

24. The mobile terminal of claim 23 wherein said threshold value relates to BER.

25. The mobile terminal of claim 23 wherein said threshold value relates to RSSI.
